(19) United States
(12) Patent Application Publication
(10) Pub. No.: US 2026/0319281 A1
(43) Pub. Date: Oct. 15, 2026

(54) METHODS PROVIDING MODULATION OF OPTICAL RETROREFLECTIVITY AND RELATED OPTICAL RETROREFLECTORS

(71) Applicant: The Government of the United States of America, as represented by the Secretary of the Navy, Arlington, VA (US)

(72) Inventors: Jacob N. Bouchard, Alexandria, VA (US); Marcel W. Pruessner, Chevy Chase, MD (US); Nathan F. Tyndall, Alexandria, VA (US); Todd H. Stievater, Arlington, VA (US)

(73) Assignee: The Government of the United States of America, as represented by the Secretary of the Navy, Arlington, VA (US)

(21) Appl. No.: 19/564,372

(22) Filed: Mar. 12, 2026

Related U.S. Application Data
(60) Provisional application No. 63/789,047, filed on Apr. 15, 2025.

(51) Int. Cl. G02F 1/035

(52) U.S. Cl. CPC G02F 1/035

(57) ABSTRACT

Some embodiments of the present disclosure provide an optical retroreflector. A first optical antenna region includes a first plurality of optical antennas, and a second optical antenna region includes a second plurality of optical antennas. A waveguide region includes a plurality of waveguides, wherein each one of the waveguides provides optical coupling between a respective one of the optical antennas of the first optical antenna region and a respective one of the optical antennas of the second optical antenna region. A phase shifting region in the waveguide region includes a plurality of phase shifting elements in the waveguide region, wherein each one of the plurality of phase shifting elements is adjacent to a respective one of the waveguides in the phase shifting region, and wherein each one of the plurality of phase shifting elements has a different length. Related methods are also disclosed.

### CROSS-REFERENCE TO RELATED APPLICATIONS

This application is a Nonprovisional Utility patent application and claims the benefit of priority under 35 U.S.C. Sec. 119 based on U.S. Provisional Patent Application No. 63/789,047 filed on Apr. 15, 2025. The disclosures of Provisional Application No. 63/789,047 and all references cited herein are hereby incorporated in their entirety by reference into the present disclosure.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #212543.

### TECHNICAL FIELD

The present disclosure generally relates to optics, and more particularly to optical retroreflectors and related methods.

### BACKGROUND

Modulating retroreflectors play an important role in free-space optical (FSO) communications (see, References [1], [2], and [3]) acting as secure pseudo-transmitters where the light is sent from the receiver to the transmitter, data is encoded, and then reflected back. Currently these systems are used for long-range FSO communications and consist of large 3D retroreflectors. A trade-off with traditional 3D retroreflectors is that the volume of the reflector is directly tied to its aperture size and thus the range over which it is retroreflective. The Van-Atta retroreflective architecture provides flat retroreflective arrays made up of antennae that simultaneously act as transmit and receive elements (see, Reference [4]). By connecting these elements with waveguides of equal lengths and arranging the antennae elements as a phased array, radiation incident on the array will be retroreflected.

Applying the Van-Atta architecture to integrated photonics to create a compact, passive, 2.5D optical retroreflector has been demonstrated utilizing silicon on insulator technology (see, Reference [5]). Next steps in the development of integrated optical Van-Atta retroreflectors may include reducing system loss, implementing the ability to modulate the retroreflected signal, and/or widening the retroreflectivity bandwidth by matching all the antenna interconnects.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, an optical retroreflector includes first and second optical antenna regions, a waveguide region, and a phase shifting region. The first optical antenna region includes a first plurality of optical antennas, and the second optical antenna region includes a second plurality of optical antennas. The waveguide region includes a plurality of waveguides, wherein each one of the waveguides provides optical coupling between a respective one of the optical antennas of the first optical antenna region and a respective one of the optical antennas of the second optical antenna region. The phase shifting region is in the waveguide region, wherein the phase shifting region includes a plurality of phase shifting elements in the waveguide region, wherein each one of the plurality of phase shifting elements is adjacent to a respective one of the waveguides in the phase shifting region, and wherein each one of the plurality of phase shifting elements has a different length.

According to some other embodiments of inventive concepts, a method provides retroreflectivity. A retroreflector is provided including first and second optical antenna regions, a waveguide region, and a phase shifting region in the waveguide region. The first optical antenna region includes a first plurality of optical antennas, and the second optical antenna region includes a second plurality of optical antennas. The waveguide region includes a plurality of waveguides, wherein each one of the waveguides provides optical coupling between a respective one of the optical antennas of the first optical antenna region and a respective one of the optical antennas of the second optical antenna region. The retroreflectivity of light received by the optical antennas of the first and second optical antenna regions is modulated by modulating an electrical signal provided to the phase shifting region.

### BRIEF DESCRIPTION OF THE DRAWINGS

Examples of embodiments of inventive concepts may be more clearly understood from the following detailed description taken in conjunction with the accompanying drawings in which:

FIG. 1A is a top-down schematic diagram illustrating a Van Atta retroreflector according to some embodiments of inventive concepts;

FIG. 1B is a block diagram illustrating a controller that can provide signals to modulate retroreflectivity of the retroreflector of FIG. 1A according to some embodiments of inventive concepts;

FIG. 2 is a cross-sectional view taken along section line A-A′ of FIG. 1A;

FIG. 3A is a plan view of a single optical antenna of FIG. 1A according to some embodiments of inventive concepts;

FIG. 3B is a cross-sectional view taken along section line 3B-3B′ of FIG. 3A according to some embodiments of inventive concepts;

FIG. 3C is a cross-sectional view taken along section line 3C-3C′ of FIG. 3A according to some embodiments of inventive concepts;

FIG. 3D is a cross-sectional view taken along section line 3D-3D′ of FIG. 3A according to some embodiments of inventive concepts;

FIG. 3E is a cross-sectional view taken along section line 3E-3E′ of FIG. 3A according to some embodiments of inventive concepts;

FIG. 4A is a cross-sectional view taken along section Line 4B-4B′ of FIGS. 1A and 4B with a serpentine heating element below the waveguides according to some embodiments of inventive concepts;

FIG. 4B is a top schematic view of phase shifting region of FIG. 1A with a serpentine heating element according to some embodiments of inventive concepts;

FIG. 4C is a cross-sectional view taken along section line 4B-4B′ through phase shifting region 105 of FIGS. 1A and 4B with a serpentine heating element above the waveguides according to some embodiments of inventive concepts;

FIG. 5A is a cross-sectional view cross-sectional view taken along section line 4B-4B′ through phase shifting region of FIGS. 1A and 4B with a serpentine heating element above the waveguides according to some embodiments of inventive concepts;

FIG. 5B is a top schematic view of phase shifting region 105 of FIG. 1A with electro-optic material according to some embodiments of inventive concepts;

FIGS. 6A and 6B are views illustrating additional details of the optical antenna of FIG. 3A according to some embodiments of inventive concepts;

FIGS. 6C and 6D are graphs illustrating results of simulations according to some embodiments of inventive concepts; and

FIG. 7 illustrates chip emissions according to some embodiments of inventive concepts.

### DETAILED DESCRIPTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes of each of the elements may be exaggerated for clarity and convenience of explanation.

The present disclosure describes efforts to provide improved optical retroreflectors, including the design of dual layer silicon nitride waveguide gratings to be used as optical antennas, measurements of their efficiency, and the design of active and passive optical Van-Atta arrays in silicon nitride. The present disclosure discusses a compact optical retroreflector made with the AIM Photonics integrated photonics platform. Designs of dual layer waveguide gratings to act as antennae for this retroreflecting array are also discussed. In addition, results from simulations and measurement of fabricated gratings are presented and discussed.

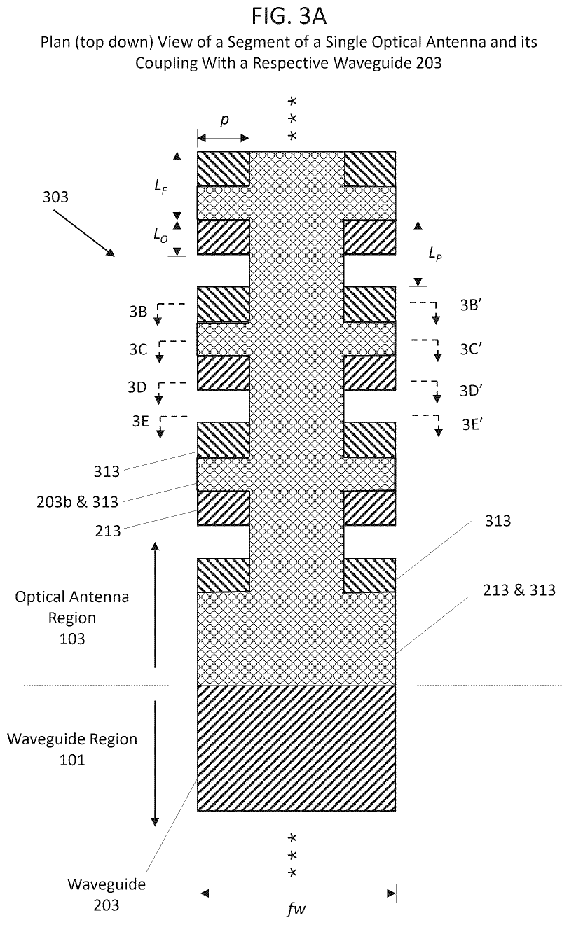

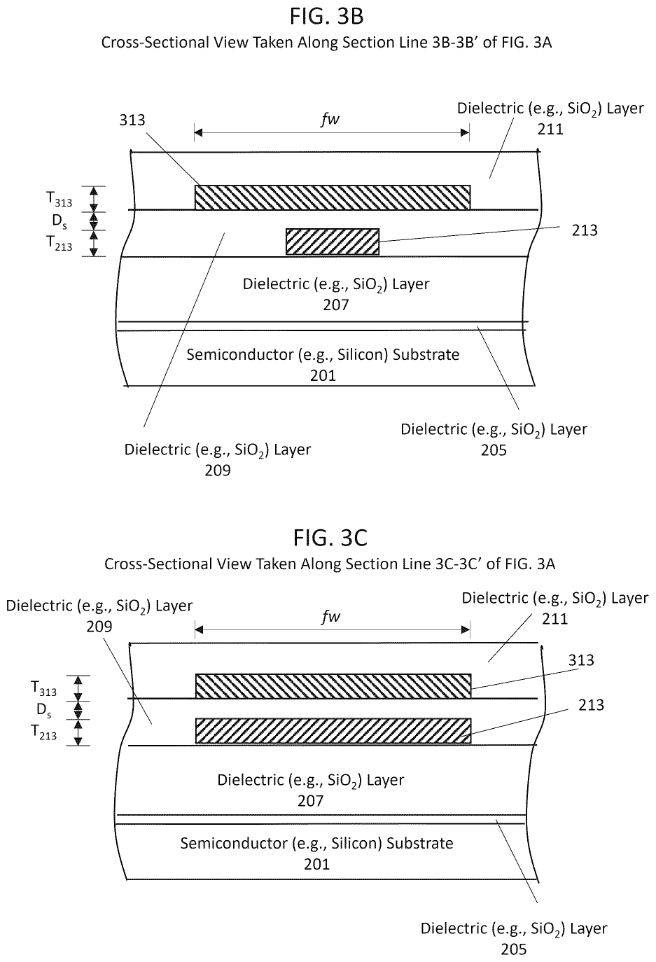

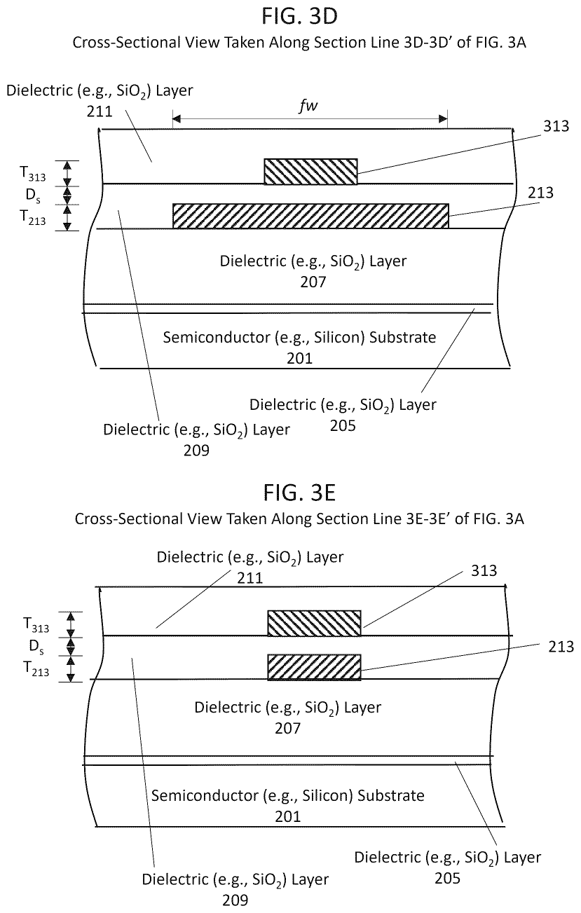

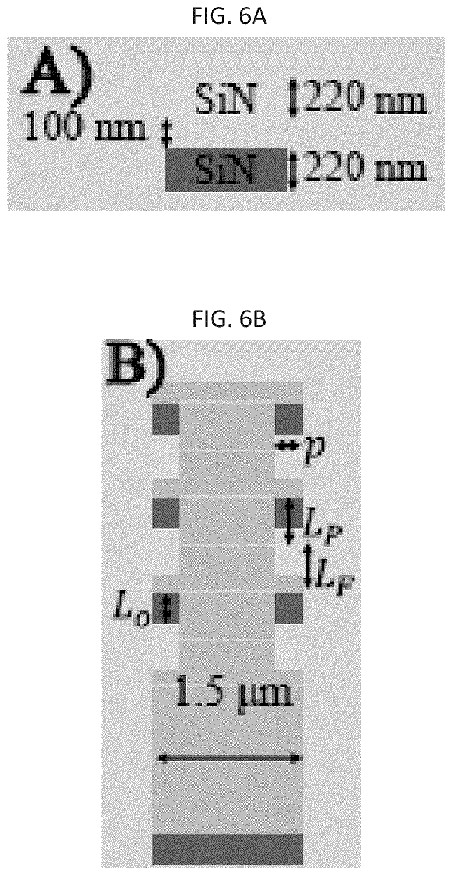

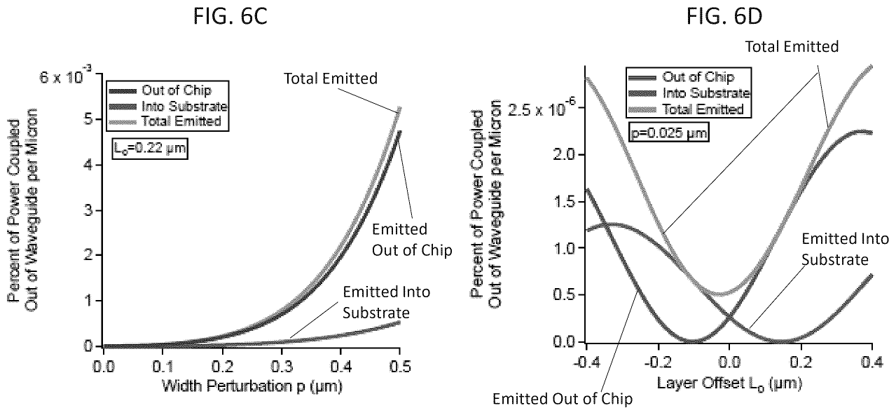

To enable the coupling of light onto and out of a photonic integrated circuit, waveguide grating couplers are typically used (see, Reference [6]). These gratings couple light incident upon the top surface of the photonic chip to a mode of a photonic waveguide. Traditional grating couplers can efficiently couple this light but are typically limited to very small angles of incidence. This may make them unsuitable for use in an integrated optical retroreflector. More recently, designs for large bilayer waveguide grating antennas have been presented (see, Reference [7]). These antennas allow for constant vertical emission over long regions by perturbing the width of a bilayer optical waveguide by a width p. An advantage to a bilayer grating structure is that by offsetting the two grating layers by some length Lₒ, the grating can be improved/optimized to increase/maximize an amount of light directed out of the chip. Diagrams showing the structure of a bilayer waveguide grating antenna are provided in FIGS. 3A, 3B, 3C, 3D, and 3E and in FIGS. 6A and 6B. The AIM Photonics SiN Passive Photonic Integrated Circuit (PIC) Multi-Project Wafer (MPW) was used, and the AIM Photonics SiN Passive PIC MPW includes a bilayer of 220 nm silicon nitride waveguides which were used to simulate and design gratings with varying layer offsets and width perturbations (shown in cross-section in FIGS. 3B, 3C, 3D, 3E, and 6A). In all these designs, the grating period was fixed such that the optical path length of one period was equal to the design wavelength λ₀. This is described below in Equation 1, where n_{full} is the effective index of the bilayer waveguide when both layers are the full width, nₜ is the effective index of the bilayer waveguide when both layers widths have been perturbed, nₘ is the effective index of the bilayer waveguide when one layer is full width and the other is perturbed, L_{f} is the length of the full width region of a layer, and Lₚ is the length of the perturbed region of a layer.

λ₀=(L_{f}−Lₒ)n_{full}+(Lₚ(p)−Lₒ)nₜ(p)+2Lₒnₘ(p) Equation (1)

Cross-sections of the bilayer waveguide structure showing layer thickness and separation are shown in FIGS. 3B, 3C, 3D, 3E, and 6A according to some embodiments of inventive concepts. Top-down views of the bilayer waveguide grating antenna with a full width fw of 1.5 μm are shown in FIGS. 3A and 6B. Moreover, SiN layers 213 and 313 may each have thicknesses T₂₁₃ and T₃₁₃ of about 200 nm, and SiN layers 213 and 313 may be separated by a distance Dₛ of about 100 nm. FIG. 6C is a graph illustrating results of a COMSOL simulation in which the perturbation p of a bilayer grating was varied from 0 μm to 0.5 μm to show its impact on directionality and grating strength. FIG. 6D is a graph illustrating results of a COMSOL simulation in which the layer offset Lₒ of a bilayer grating was varied from −0.4 μm to 0.4 μm, to demonstrate its relationship with emission directionality.

Using two layers of silicon nitride (i.e., SiN layers 213 and 313) in the waveguide may bias emission into free space providing increased collection and emission efficiency. In addition, apodization may provide more uniform emission and collection. Moreover, offsetting the grating layers may provide directional tuning.

The gratings discussed herein with respect to FIG. 6D were designed to have a fixed L_{f} of 500 nm and with Lₚ being allowed to vary to meet the constraint in Equation 1. The offset (Lₒ) was swept between −0.4 μm and 0.4 μm to quantify its impact on directionality and find offsets for increased/maximum off-chip emission. The perturbation p was swept from 0.025 μm to 0.5 μm to eventually apodize these gratings. COMSOL Multiphysics was used to find the effective indices of the bilayer waveguides and to simulate the emission from these gratings. The results of these simulations can be seen in FIGS. 6C and 6D. From these simulations, an offset of Lₒ=0.22 μm was found to result in the most efficient emission. Grating designs from both of these parameter sweeps were selected and submitted for fabrication.

The fabricated gratings were measured using tunable laser light centered at 1550 nm that was coupled into and out of the chip using cleaved single-mode fibers aligned to on-chip inverse taper edge couplers. The gratings were approximately 3 mm long. The waveguides outside of the grating region were provided using a single layer, 1.5 μm wide, silicon nitride core. Custom edge couplers were used at the edge of the chip to improve coupling efficiency between the waveguides and the fibers. The transmission through the waveguide after the 3 mm grating segment was measured using a photodetector.

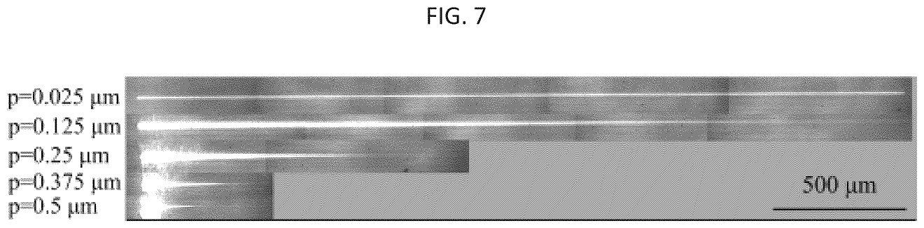

The results of these measurements, as well as the predicted loss from simulations, can be seen in Table 1 below. Top-down images of the out of chip emission from some of the gratings are shown in FIG. 7. The disagreement between the measured and simulated grating response may be due to a width offset in the fabricated device. Another factor that could impact the accuracy of the simulations is the possible variations of the material indices in the waveguide layers. Simulations herein assume that both silicon nitride layers have the same refractive index at the same width, which may not be accurate as the deposition of the top layer may change the index of the bottom layer. Ultimately, the results from this study will be used to calibrate future simulations to better reflect fabricated devices.

TABLE 1
Simulated and measured loss through the grating structures.

| Lₒ (μm) | p (μm) | Simulated Loss (dB) | Measured Loss (dB) |
|---|---|---|---|
| −0.40 | 0.025 | −0.380 | −0.96 +/− 0.4 |
| −0.22 | 0.025 | −0.390 | −1.17 +/− 0.3 |
| −0.14 | 0.025 | −0.340 | −1.63 +/− 0.1 |
| 0.00 | 0.025 | −0.320 | −2.27 +/− 0.2 |
| 0.14 | 0.025 | −0.390 | −1.94 +/− 0.2 |
| 0.22 | 0.025 | −0.470 | −1.23 +/− 0.1 |
| 0.22 | 0.125 | −1.702 | −22.14 +/− 2.0 |
| 0.40 | 0.025 | −0.350 | −0.82 +/− 0.5 |

FIG. 7 illustrates Top-Down images of emission along waveguide gratings disclosed herein at a wavelength of 1550 μm. Eight optical Van-Atta retroreflecting arrays were laid out on the same chip as the waveguide gratings described above. These arrays consist of eight input/output gratings split into two groups of 4 which are spaced at either 1.5 λ₀, 3 λ₀, or 4 λ₀, depending on the array. The two groups of 4 gratings are connected with single layer silicon nitride waveguides of matching lengths. In four of the eight Van-Atta arrays, titanium nitride thermo-optic phase shifters were added to the waveguide interconnects to allow modulation of the retroreflectivity of the arrays at frequencies on the order of about 10 kHz.

These Van-Atta arrays use modified waveguide gratings which were designed to receive and emit uniformly over their 3 mm length by varying their grating strength along the length of the grating. Since the grating emission is much stronger than designed, the apodization did not result in uniform emission and the gratings emit all the light coupled into them within the first few tens of microns. As a result, the fabricated Van-Atta arrays were not able to be measured as part of this work.

The present disclosure discusses the design, simulation, and test of waveguide gratings for planar retroreflecting arrays using the AIM Photonics MPW platform. Designed gratings were stronger than predicted, possibly due to effective index or geometry variations in manufacturing. Future work may include measurements of the light coupled out of the gratings to verify the source of the waveguide loss in test structures and measurements of the effective index of both silicon nitride layers to verify material and geometry assumptions made in the simulations.

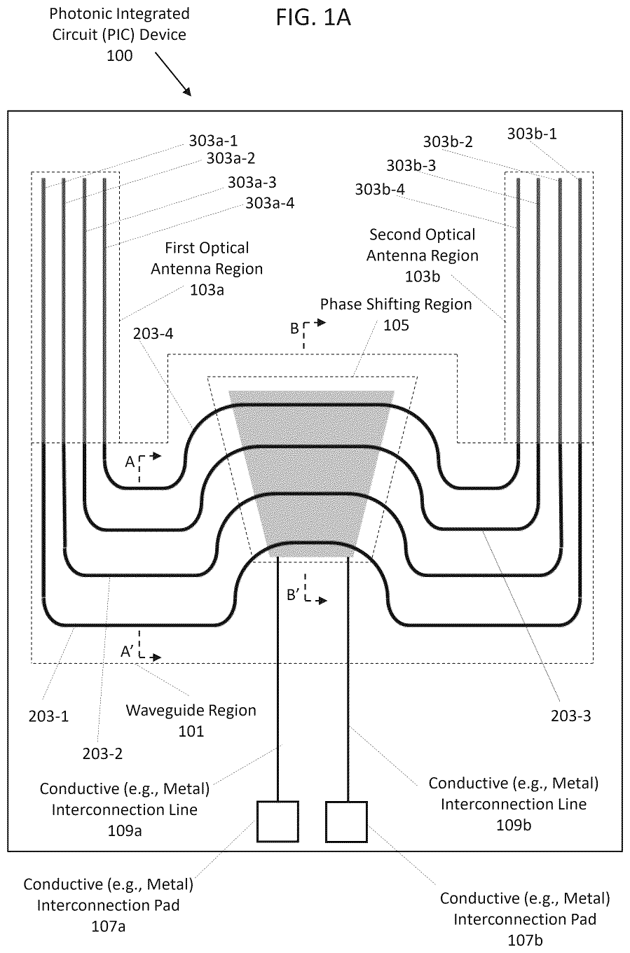

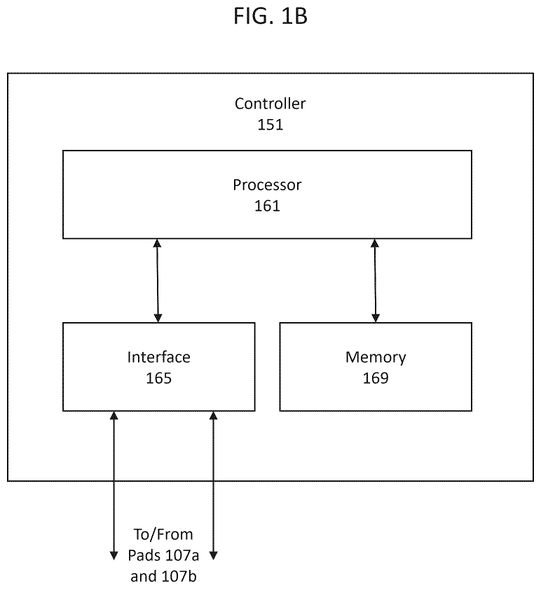

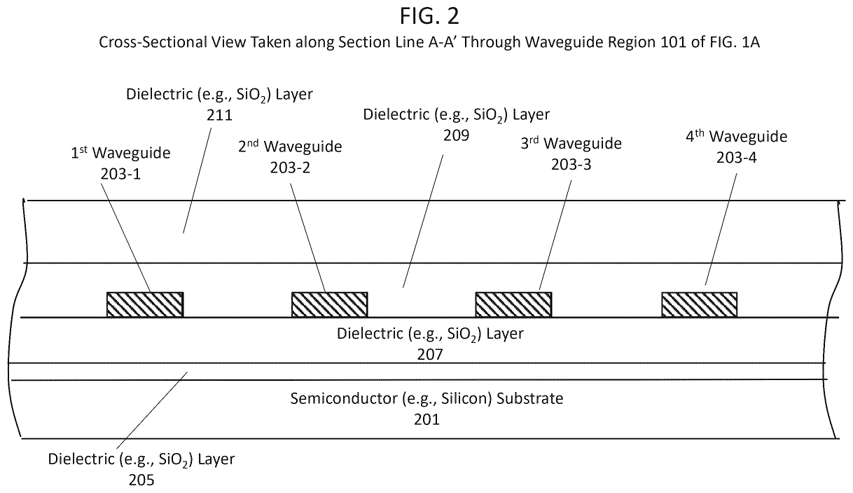

FIG. 1A is a top-down schematic illustration of a Van Atta retroreflector provided as a photonic integrated circuit (PIC) device according to some embodiments of inventive concepts. The retroreflector includes waveguide region 101 optically coupled between first and second optical antenna regions 103a and 103b. In the example of FIG. 1A, waveguide region 101 includes four waveguides 203-1, 203-2, 203-3, and 203-4; first optical antenna region 103a includes four optical antennas 303a-1, 303a-2, 303a-3, and 303a-4; and second optical antenna region 103b includes four optical antennas 303b-1, 303b-2, 303b-3, and 303b-4. Moreover, each waveguide of waveguide region 101 is optically coupled between a respective optical antenna of first optical antenna region 103a and a respective optical antenna of second optical antenna region 103b. In the embodiment of FIG. 1A, waveguide region 101 includes 4 waveguides, and each of first and second optical antenna regions 103a and 103b includes 4 optical antennas. According to other embodiments of inventive concepts, waveguide region 101 and optical antenna regions 103a and 103b may include any number of waveguides and corresponding optical antennas. By connecting arrays of optical antennas (also referred to as arrays of gratings) with waveguides of matches lengths, broadband retroreflection may be provided.

The retroreflector of FIG. 1A can thus provide retroreflection of light meaning that light is reflected/transmitted back in the same direction from which it was received. More particularly, light received from a given direction by optical antennas 303a-1, 303a-2, 303a-3, and 303a-4 of optical antenna region 103a can be transmitted out of optical antennas 303b-1, 303b-2, 303b-3, and 303b-4 of optical antenna region 103b in the same given direction; and at the same time, light received by optical antennas 303b-1, 303b-2, 303b-3, and 303b-4 from the given direction of optical antenna region 103b can be transmitted out of optical antennas 303a-1, 303a-2, 303a-3, and 303a-4 of optical antenna region 103a in the same given direction.

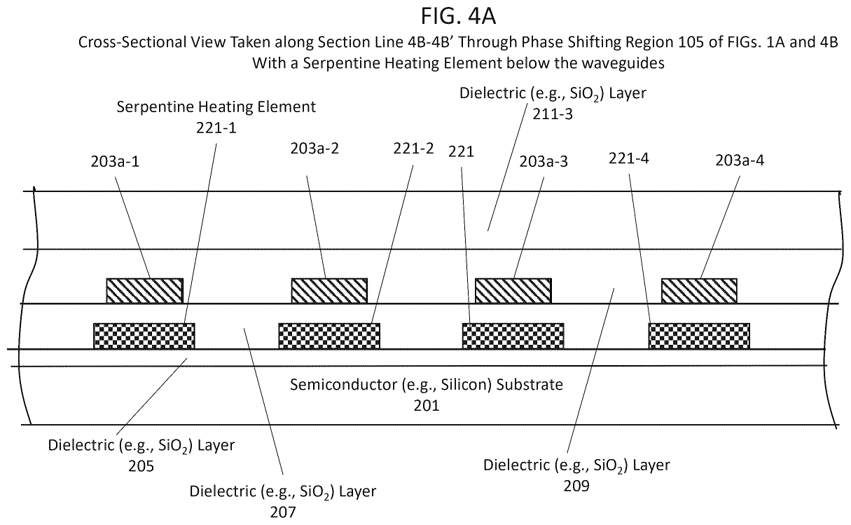

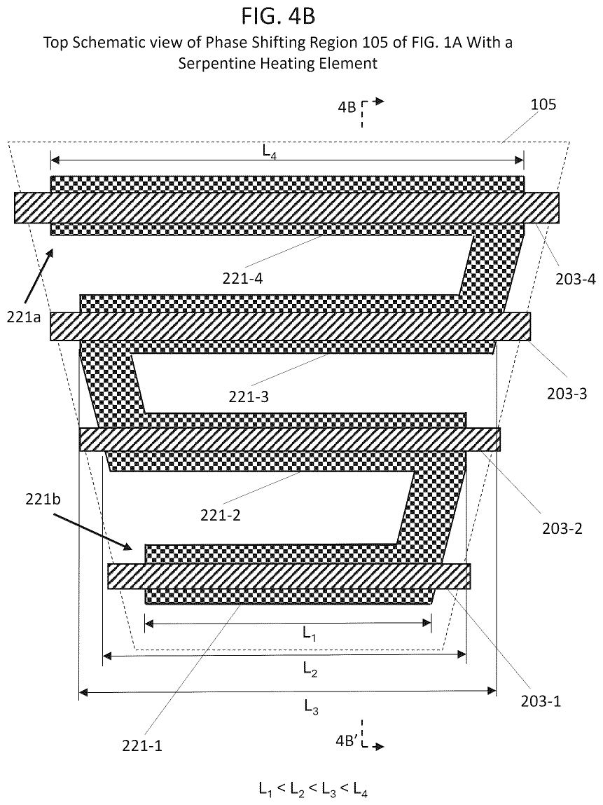

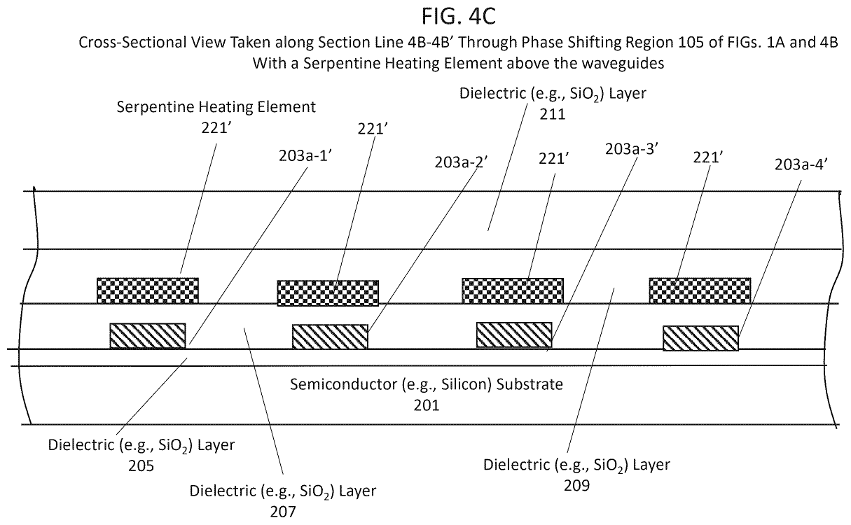

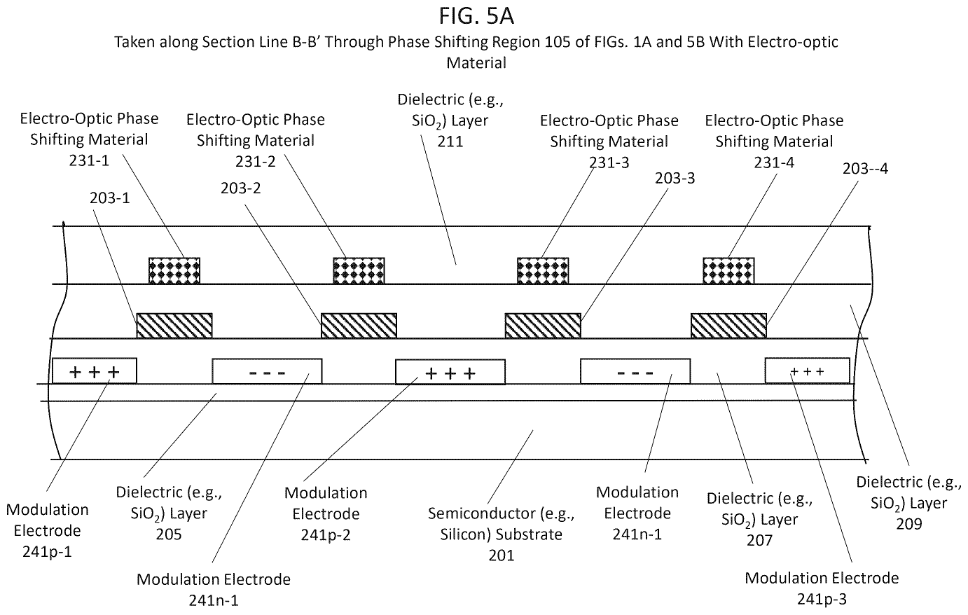

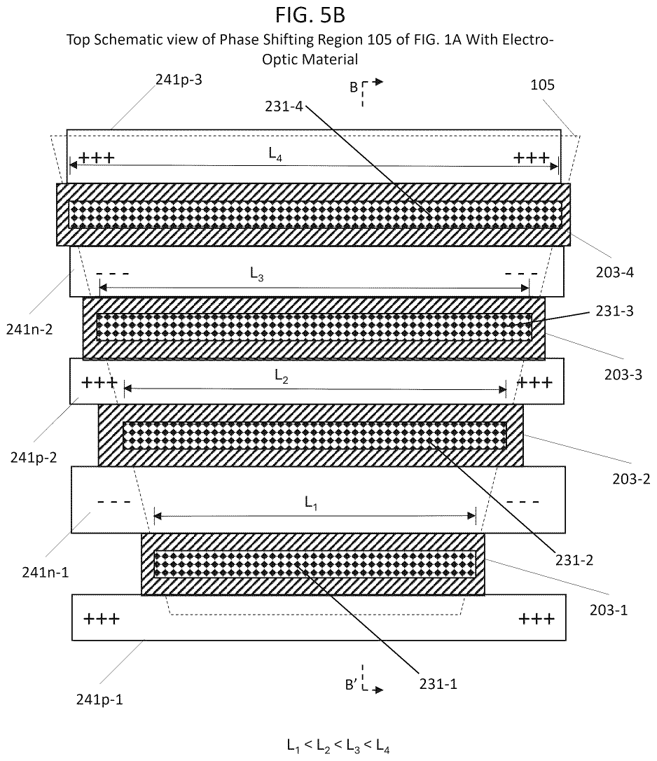

In addition, phase shifting region 105 is provided in waveguide region 101 to differentially shift phases of light passing through waveguides 203-1, 203-2, 203-3, and 203-4 responsive to an electrical signal applied thereto via conductive interconnection pads 107a and 107b and conductive interconnection lines 109a and 109b. Accordingly, retroreflection can be turned on and off by differentially shifting phases of light passing through the waveguides. For example, a first electrical signal (e.g., 0 volts) may be applied to phase shifting region 105 so that optical lengths of waveguides 203-1, 203-2, 203-3, and 203-4 are matched to provide optical retroreflection; and a second electrical signal (e.g., not equal to zero volts) may be applied to phase shifting region so that optical lengths of waveguides 203-1, 203-2, 203-3, and 203-4 are unmatched to block optical retroreflection. According to some embodiments discussed below with respect to FIGS. 4A, 4B, and 4C, phase shifting region 105 may provide differential heating of waveguides 203-1, 203-2, 203-3, and 203-4 to differentially shift the phases to block retroreflection. According to some other embodiments discussed below with respect to FIGS. 5A and 5B, phase shifting region 105 may differentially expose waveguides 203-1, 203-2, 203-3, and 203-4 to electric fields and/or electro-optic phase shifting material to block retroreflection.

FIG. 1B is a block diagram illustrating controller 151 that can provide electrical signals to phase shifting region 105 to modulate (e.g., provide/block) retroreflectivity of light received by optical antennas 303a-1 to 303a-4 and 303b-1 to 303b-4 of regions 103a and 103b. Controller 151 of FIG. 4 may include processor 161 (also referred to as processor circuitry), interface 161 (also referred to as interface circuitry) coupled with processor 161, and memory 169 (also referred to as memory circuitry) coupled with processor 161. Interface 165 is configured to couple signaling between processor 161 and pads 107a and 107b. Memory 169 includes computer readable program code that when executed by processor 161 causes processor 161 to perform operations according to embodiments disclosed herein. According to other embodiments, processor 161 may be defined to include memory so that a separate memory is not required. Accordingly, processor 161 of controller 151 is configured to transmit control signaling through interface circuitry 165, pads 107a and 107b, and lines 109a and 109b to modulated phase shifting region 105 as disclosed herein. More particularly, processor 161 may be configured to: provide a first electrical signal (e.g., a low/zero volt signal) to phase shifting region 105 to provide retroreflectivity of light received by the optical antennas of the first and second optical antenna regions; and provide a second electrical signal (e.g., a non-zero volt signal with an absolute value greater than the first electrical signal) to phase shifting region 105 to block retroreflectivity of light received by the optical antennas of first and second optical antenna regions 103a and 103b, with the first and second electrical signals being different.

According to some embodiments of inventive concepts, controller 151 may thus be configured to modulate the retroreflectivity of light received by optical antennas 303 of first and second optical antenna regions 103a and 103b by modulating an electrical signal provided to phase shifting region. Modulating the electrical signal may include providing a first electrical signal to the phase shifting region to provide a first level of retroreflectivity of light received by the optical antennas of the first and second optical antenna regions; and providing a second electrical signal to the phase shifting region to provide a second level of retroreflectivity of light received by the optical antennas of the first and second optical antenna regions, wherein the first and second electrical signals are different, and wherein the first and second levels of retroreflectivity are different. For example, an absolute value of the first electrical signal may be less than an absolute value of the second electrical signal, and the first level of reflectivity may be greater than the second level of reflectivity. Moreover, providing the second level of retroreflectivity less than the first level of retroreflectivity may include blocking retroreflectivity of light received by the optical antennas of the first and second optical antenna regions.

According to some embodiments of inventive concepts, controller 151 may be provided separate from PIC device 100 and semiconductor substrate 201. In such embodiments, interface circuitry 165 may be electrically coupled with pads 107a and 107b, for example, via wire bonds, solder bonds, etc. According to some other embodiments of inventive concepts, controller 151 and/or elements thereof may be integrated on PIC 100 with electronic circuitry of controller 151 (e.g., transistors, resistors, diodes, capacitors, etc.) being fabricated in/on semiconductor substrate 201.

FIG. 2 is a cross-sectional view taken along section line A-A′ of FIG. 1A illustrating waveguides 203-1, 203-2, 203-3, and 203-4 in waveguide region 101 (outside of phase shifting region 105). As shown in the cross-sections of FIGS. 2, 3B-E, 4A, 4C, and 5A, retroreflectors according to some embodiments disclosed herein may be fabricated using a photonic integrated circuit (PIC) process on semiconductor substrate 201 (e.g., a silicon substrate) and dielectric layer 205 (e.g., SiO₂). The structure includes: dielectric layers (e.g., SiO₂ layers) 207, 209, and 211; a first SiN layer patterned to provide waveguides 203 and lower SiN layers 213 of optical antennas; and a second SiN layer patterned to provide upper SiN layers 313 of optical antennas. While SiO₂ is discussed by way of example for use as a dielectric material and SiN is discussed by way of example as an optical transmission material, other materials may be used. For example, different materials may be used provided that a refractive index of the dielectric material is less than a refractive index of the optical transmission material. For example, silicon nitride, aluminum nitride and/or silicon may be used as optical transmission waveguide materials.

FIG. 3A is a plan view of a segment of a waveguide grating array that may be used to implement one of the optical antennas 303 of an optical region 103 of FIG. 1A, and FIGS. 3B, 3C, 3D, and 3E are cross-sectional views taken along section lines 3B-3B′, 3C-3C′, 3D-3D′, and 3E-3E′, respectively. As indicated by ellipses in FIG. 3A, only a portion of the waveguide grating is shown, and the pattern of FIG. 3A may be repeated any number of times to provide a desired length. According to some embodiments, a waveguide grating array may have a length of about 3 mm. As further shown in FIGS. 3A-E, lower silicon nitride layer 213 of waveguide grating array 103 may be coupled to a respective waveguide 203. Moreover, lower silicon nitride layers 213 of the optical antennas and silicon nitride layers of waveguides 203 may be patterned from a same silicon nitride layer. The structures and dimensions of FIGS. 3A-E may be the same as those discussed with respect to FIGS. 6A and 6B.

FIGS. 4A, 4B, and 4C illustrate phase shifting region 105 of FIG. 1A according to some embodiments of inventive concepts with serpentine heating element 221 used to differentially heat sections of waveguides 203-1, 203-2, 203-3, and 203-4. As shown in FIG. 4A, serpentine heating element 221 may be provided between substrate 201 and waveguides 203 according to some embodiments of inventive concepts. As shown in FIG. 4C, waveguides 203 may be provided between substrate 201 and serpentine heating element 221′ according to some other embodiments of inventive concepts.

In FIGS. 4A, 4B, and 4C, heating element 221 may be provided, for example, using a metal line and/or a doped polysilicon line. In FIG. 4A, heating element may be provided using doped portions of semiconductor substrate 201.

As shown in FIG. 4B, a first segment 221-1 of heating element 221 having a first length L₁ may be provided adjacent a portion of waveguide 203-1, a second segment 221-2 of heating element 221 having a second length L₂ may be provided adjacent a portion of waveguide 203-2, a third segment 221-3 of heating element 221 having a third length L₃ may be provided adjacent a portion of waveguide 203-3, and a fourth segment 221-4 of heating element 221 having a fourth length L₄ may be provided adjacent a portion of waveguide 203-4. Moreover, all the lengths L₁, L₂, L₃, and L₄ are different (e.g., L₁<L₂<L₃<L₄) to provide differential heating (and thus differential phase shifting) for the waveguides when an electrical signal is applied to serpentine heating element 221 via pads 107a-b and lines 109a-b to generate an electrical current through heating element 221 and provide resistive heating. According to some embodiments, L₁ in FIG. 4B may be zero to increase a differential of heating between waveguide 203-1 and the other waveguides.

More particularly, conductive line 109a may be electrically coupled with a first end 221a of heating element 221, and conductive line 109b may be electrically coupled with a second end 221b of heating element 221 so that an electrical signal applied by controller 151 across pads 107a and 107b results in an electrical current through heating element 221. When a first electrical signal (e.g., a low/zero volt electrical signal) is applied by controller 151 across pads 107a and 107b, no/little electrical current flows through heating element 221, and no/little heating of the waveguides occurs. Accordingly, there is little/no differential heating of the waveguides, and retroreflection is allowed/provided. When a second electrical signal (e.g., a sufficiently non-zero volt electrical signal) is applied by controller 151 across pads 107a and 107b, electrical current flows through heating element 221 to differentially heat the waveguides based on the differential lengths of the heating element segments adjacent to the respective waveguides. The differential heating of the waveguides results in differential phase shifts for the waveguides so that retroreflection is blocked.

FIGS. 5A and 5B illustrate phase shifting region 105 of FIG. 1A according to some other embodiments of inventive concepts. In FIGS. 5A and 5B, segments of electro-optic phase shifting material 231-1, 231-2, 231-3, and 231-4 are provided adjacent to segments of respective waveguides 203-1, 203-2, 203-3, and 203-4, and alternating positive and negative modulation electrodes 241p-1, 241n-1, 241p-2, 241n-2, and 241p-3 are provided between/adjacent ones of the waveguides. Moreover, positive modulation electrodes 241p-1, 241p-2, and 241p-3 may be electrically coupled with conductive line 109a, and negative modulation electrodes 241n-1 and 241n-2 may be electrically coupled with conductive line 109b. When a first electrical signal (e.g., a low/zero volt electrical signal) is applied by controller 151 across pads 107a and 107b, little/no electrical field is generated through the segments of electro-optic phase shifting material, and little/no differential phase shifting in the waveguides occurs. When a second electrical signal (e.g., a sufficiently non-zero volt electrical signal) is applied by controller 151 across pads 107a and 107b, an electrical field is generated through the segments of electro-optic phase shifting material to provide differential phase shifts in the respective waveguides based on the differential lengths of the segments of the electro-optic phase shifting material adjacent to the respective waveguides. According to some embodiments, L₁ in FIG. 5B may be zero to increase a differential of phase shifting between waveguide 203-1 and the other waveguides.

In FIGS. 5A and 5B, modulation electrodes 241 may be provided, for example, using metal lines, doped polysilicon lines, and/or doped portions of semiconductor substrate 201. Moreover, electro-optic phase shifting material 231 may be provided using aluminum nitride and/or barium titanate.

As shown in FIGS. 5A and 5B, electro-optic phase shifting material 231 may be above the waveguides, and modulation electrodes 241 may be below the waveguides. According to some other embodiments of inventive concepts, these placements may be reversed with the modulation electrodes 241 above the waveguides and the electro-optic phase shifting material 231 below the waveguides. Electro-optic phase shifting materials of FIGS. 5A and 5B may provide modulation of retroreflectivity at frequencies on the order of 50 GHz.

Embodiments of the present disclosure may thus provide integrated and planar optical retroreflectors that can be modulated and that are compatible with photonics foundry manufacturing processes. These retroreflectors may be useful components for systems providing secure free space optical communication links, and/or for compact optical markers used for example in unmanned arial vehicle (UAV) navigation and/or infrared (IR) machine vision systems. Moreover, these retroreflectors may operate across the optical C-band (e.g., from about 1530 nm to about 1565 nm) over 15 degrees and at increased efficiency. Compared with bulky 3-dimensional retroreflector architectures, retroreflectors of the present disclosure may be relatively small, may use less power, and/or may provide increased efficiency, providing size, weight, and/or power (SWaP) advantages.

Examples of some embodiments of inventive concepts are provided below.

Embodiment 1. An optical retroreflector comprising: a first optical antenna region (103a) including a first plurality of optical antennas (303a-1, 303a-2, 303a-3, 303a-4); a second optical antenna region (103b) including a second plurality of optical antennas (303b-1, 303b-2, 303b-3, 303b-4); a waveguide region (101) including a plurality of waveguides (203-1, 203-2, 203-3, 203-4), wherein each one of the waveguides provides optical coupling between a respective one of the optical antennas of the first optical antenna region and a respective one of the optical antennas of the second optical antenna region; and a phase shifting region (105) in the waveguide region, wherein the phase shifting region includes a plurality of phase shifting elements (221-1, 221-2, 221-3, 221-4; 231-1, 231-2, 231-3, 231-4) in the waveguide region, wherein each one of the plurality of phase shifting elements is adjacent to a respective one of the waveguides in the phase shifting region, and wherein each one of the plurality of phase shifting elements has a different length (L₁, L₂, L₃, L₄).

Embodiment 2. The optical retroreflector according to Embodiment 1, wherein the each of the plurality of phase shifting elements comprises a respective segment (221-1, 221-2, 221-3, 221-4) of a continuous heating element (221), wherein each segment is adjacent to the respective one of the waveguides.

Embodiment 3. The optical retroreflector according to Embodiment 2, wherein the continuous heating element comprises a continuous serpentine heating element.

Embodiment 4. The optical retroreflector according to Embodiment 1, wherein each of the plurality of phase shifting elements comprises a respective segment (231-1, 231-2, 231-3, 231-4) of an electro-optic phase shifting material, wherein each segment of the electro-optic phase shifting material is adjacent to the respective one of the waveguides.

Embodiment 5. The optical retroreflector according to Embodiment 4, further comprising: a plurality of alternating positive and negative modulation electrodes (241p-1, 241n-1, 241p-2, 241n-2, 241p-3) adjacent the segments of the electro-optic phase shifting material.

Embodiment 6. The optical retroreflector according to any of Embodiments 4-5, wherein the electro-optic phase shifting material comprises at least one of aluminum nitride and/or barium titanate.

Embodiment 7. The optical retroreflector according to any of Embodiments 1-6, wherein the each of the waveguides comprises at least one of silicon nitride, aluminum nitride, and/or silicon.

Embodiment 8. The optical retroreflector according to any of Embodiments 1-7 further comprising: a semiconductor substrate (201); and a dielectric layer (205) on the semiconductor substrate, wherein the dielectric layer is between the first plurality of optical antennas and the semiconductor substrate, wherein the dielectric layer is between the second plurality of optical antennas and the semiconductor substrate, and wherein the dielectric layer is between the plurality of waveguides and the semiconductor substrate.

Embodiment 9. The optical retroreflector according to Embodiment 8, wherein the dielectric layer comprises silicon dioxide.

Embodiment 10. The optical retroreflector according to any of Embodiments 1-9 further comprising: a controller (151) electrically coupled with the phase shifting region, wherein the controller is configured to modulate the retroreflectivity of light received by the optical antennas of the first and second optical antenna regions by modulating an electrical signal provided to the phase shifting region.

Embodiment 11. The optical retroreflector according to Embodiment 10, wherein modulating the electrical signal comprises: providing a first electrical signal to the phase shifting region to provide a first level of retroreflectivity of light received by the optical antennas of the first and second optical antenna regions; and providing a second electrical signal to the phase shifting region to provide a second level of retroreflectivity of light received by the optical antennas of the first and second optical antenna regions, wherein the first and second electrical signals are different, and wherein the first and second levels of retroreflectivity are different.

Embodiment 12. The optical retroreflector according to Embodiment 11, wherein the first level of reflectivity is greater than the second level of reflectivity.

Embodiment 13. The optical retroreflector according to Embodiment 12, wherein providing the second level of retroreflectivity comprises blocking retroreflectivity of light received by the optical antennas of the first and second optical antenna regions.

Embodiment 14. A method providing retroreflectivity, the method comprising: providing a retroreflector including, a first optical antenna region (103a) comprising a first plurality of optical antennas (303a-1, 303a-2, 303a-3, 303a-4), a second optical antenna region (103b) comprising a second plurality of optical antennas (303b-1, 303b-2, 303b-3, 303b-4), a waveguide region (101) comprising a plurality of waveguides (203-1, 203-2, 203-3, 203-4), wherein each one of the waveguides provides optical coupling between a respective one of the optical antennas of the first optical antenna region and a respective one of the optical antennas of the second optical antenna region, and a phase shifting region (105) in the waveguide region; modulating the retroreflectivity of light received by the optical antennas of the first and second optical antenna regions by modulating an electrical signal provided to the phase shifting region.

Embodiment 15. The method according to Embodiment 14, wherein modulating the electrical signal comprises: providing a first electrical signal to the phase shifting region to provide a first level of retroreflectivity of light received by the optical antennas of the first and second optical antenna regions; and providing a second electrical signal to the phase shifting region to provide a second level of retroreflectivity of light received by the optical antennas of the first and second optical antenna regions, wherein the first and second electrical signals are different, and wherein the first and second levels of retroreflectivity are different.

Embodiment 16. The method according to Embodiment 15, wherein the first level of reflectivity is greater than the second level of reflectivity.

Embodiment 17. The method according to Embodiment 16, wherein providing the second level of retroreflectivity comprises blocking retroreflectivity of light received by the optical antennas of the first and second optical antenna regions.

Embodiment 18. The method according to any of Embodiment 14-17, wherein the phase shifting region includes a plurality of phase shifting elements (221-1, 221-2, 221-3, 221-4; 231-1, 231-2, 231-3, 231-4) in the waveguide region, wherein each one of the plurality of phase shifting elements is adjacent to a respective one of the waveguides in the phase shifting region, and wherein each one of the plurality of phase shifting elements has a different length (L₁, L₂, L₃, L₄)

Embodiment 19. The method according to Embodiment 18, wherein the each of the plurality of phase shifting elements comprises a respective segment (221-1, 221-2, 221-3, 221-4) of a continuous heating element (221), wherein the first electrical signals are applied across opposite ends of the continuous heating element, and wherein the second electrical signal is applied across opposite ends of the continuous heating element.

Embodiment 20. The method according to Embodiment 19, wherein the continuous heating element comprises a continuous serpentine heating element.

Embodiment 21. The method according to Embodiment 18, wherein each of the plurality of phase shifting elements comprises a respective segment (231-1, 231-2, 231-3, 231-4) of an electro-optic phase shifting material.

Embodiment 22. The method according to Embodiment 21, wherein the phase shifting region further includes a plurality of alternating positive and negative modulation electrodes (241p-1, 241n-1, 241p-2, 241n-2, 241p-3) adjacent the segments of the electro-optic phase shifting material, wherein the first electrical signal is provided across the alternating positive and negative modulation electrodes to generate first electrical fields through the segments of the electro-optic phase shifting material, and wherein the second electrical signal is provided across the alternating positive and negative modulation electrodes to generate second electrical fields through the segments of the electro-optic phase shifting material.

Complete citations are provided below for publications cited in the foregoing disclosure, and the disclosures of all the cited publications are hereby incorporated herein in their entirety by reference.
Reference [1] RABINOVICH, W. S., et al., “Free space optical communication link using a silicon photonic optical phased array,” Proceedings of the SPIE (US), Vol. 9354, pages 96-101, March 2015.
Reference [2] GOETZ, P. G., et al., “Modulating retroreflector implementation of mil-std-1553 protocol with free-space optics,” IEEE Aerospace Conf Proc (US), Vol. 4, Paper No. 1559, pages 1799-1808, February 2003.
Reference [3] GOETZ, P. G., et al., “Practical considerations of retroreflector choice in modulating retroreflector systems,” Digest of the LEOS Summer Topical Meetings (US), pages 49-50, 2005.
Reference [4] VAN ATTA, L. C., U.S. Pat. No. 2,908,002, “Electromagnetic reflector,” (Oct. 6, 1959).
Reference [5] VAN ACOLEYEN, K., et al. “Optical retroreflective marker fabricated on silicon-on-insulator,” IEEE Photonics Journal (US), Vol. 3, No, 5, pages 789-798, October 2011.
Reference [6] CHENG, L., et al., “Grating couplers on silicon photonics: Design principles, emerging trends and practical issues,” Micromachines (CH), Vol. 11, No. 7, 666, 25 pages, Jul. 8, 2020.
Reference [7] RAVAL, M., et al., “Unidirectional waveguide grating antennas with uniform emission for optical phased arrays,” Optics letters (US), Vol. 42, Issue 13, pages 2563-2566, Jun. 28, 2017.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present inventive concepts.

It will also be understood that when an element is referred to as being on or connected to/with or coupled to/with another element, it can be directly on or connected to/with or coupled to/with the other element, or intervening elements may be present. In contrast, when an element is referred to as being directly on or directly connected to/with or directly coupled to/with another element, there are no intervening elements present. Moreover, if an element is referred to as being “on” another element, no spatial orientation is implied such that the element can be over the other element, under the other element, on a side of the other element, etc.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the spirit of the following claims.

1. An optical retroreflector comprising:
a first optical antenna region including a first plurality of optical antennas;
a second optical antenna region including a second plurality of optical antennas;
a waveguide region including a plurality of waveguides, wherein each one of the waveguides provides optical coupling between a respective one of the optical antennas of the first optical antenna region and a respective one of the optical antennas of the second optical antenna region; and
a phase shifting region in the waveguide region, wherein the phase shifting region includes a plurality of phase shifting elements in the waveguide region, wherein each one of the plurality of phase shifting elements is adjacent to a respective one of the waveguides in the phase shifting region, and wherein each one of the plurality of phase shifting elements has a different length.

2. The optical retroreflector according to claim 1, wherein the each of the plurality of phase shifting elements comprises a respective segment of a continuous heating element, wherein each segment is adjacent to the respective one of the waveguides.

3. The optical retroreflector according to claim 2, wherein the continuous heating element comprises a continuous serpentine heating element.

4. The optical retroreflector according to claim 1, wherein each of the plurality of phase shifting elements comprises a respective segment of an electro-optic phase shifting material, wherein each segment of the electro-optic phase shifting material is adjacent to the respective one of the waveguides.

5. The optical retroreflector according to claim 4, further comprising:
a plurality of alternating positive and negative modulation electrodes adjacent the segments of the electro-optic phase shifting material.

6. The optical retroreflector according to claim 4, wherein the electro-optic phase shifting material comprises at least one of aluminum nitride and/or barium titanate.

7. The optical retroreflector according to claim 1, wherein the each of the waveguides comprises at least one of silicon nitride, aluminum nitride, and/or silicon.

8. The optical retroreflector according to claim 1 further comprising:
a semiconductor substrate; and
a dielectric layer on the semiconductor substrate, wherein the dielectric layer is between the first plurality of optical antennas and the semiconductor substrate, wherein the dielectric layer is between the second plurality of optical antennas and the semiconductor substrate, and wherein the dielectric layer is between the plurality of waveguides and the semiconductor substrate.

9. The optical retroreflector according to claim 8, wherein the dielectric layer comprises silicon dioxide.

10. The optical retroreflector according to claim 1 further comprising:
a controller electrically coupled with the phase shifting region, wherein the controller is configured to modulate the retroreflectivity of light received by the optical antennas of the first and second optical antenna regions by modulating an electrical signal provided to the phase shifting region.

11. The optical retroreflector according to claim 10, wherein modulating the electrical signal comprises:
providing a first electrical signal to the phase shifting region to provide a first level of retroreflectivity of light received by the optical antennas of the first and second optical antenna regions; and
providing a second electrical signal to the phase shifting region to provide a second level of retroreflectivity of light received by the optical antennas of the first and second optical antenna regions, wherein the first and second electrical signals are different, and wherein the first and second levels of retroreflectivity are different.

12. The optical retroreflector according to claim 11, wherein the first level of reflectivity is greater than the second level of reflectivity.

13. The optical retroreflector according to claim 12, wherein providing the second level of retroreflectivity comprises blocking retroreflectivity of light received by the optical antennas of the first and second optical antenna regions.

14. A method providing retroreflectivity, the method comprising:
providing a retroreflector including,
a first optical antenna region comprising a first plurality of optical antennas,
a second optical antenna region comprising a second plurality of optical antennas,
a waveguide region comprising a plurality of waveguides, wherein each one of the waveguides provides optical coupling between a respective one of the optical antennas of the first optical antenna region and a respective one of the optical antennas of the second optical antenna region, and
a phase shifting region in the waveguide region;
modulating the retroreflectivity of light received by the optical antennas of the first and second optical antenna regions by modulating an electrical signal provided to the phase shifting region.

15. The method according to claim 14, wherein modulating the electrical signal comprises:
providing a first electrical signal to the phase shifting region to provide a first level of retroreflectivity of light received by the optical antennas of the first and second optical antenna regions; and
providing a second electrical signal to the phase shifting region to provide a second level of retroreflectivity of light received by the optical antennas of the first and second optical antenna regions, wherein the first and second electrical signals are different, and wherein the first and second levels of retroreflectivity are different.

16. The method according to claim 15, wherein the first level of reflectivity is greater than the second level of reflectivity.

17. The method according to claim 16, wherein providing the second level of retroreflectivity comprises blocking retroreflectivity of light received by the optical antennas of the first and second optical antenna regions.

18. The method according to claim 14, wherein the phase shifting region includes a plurality of phase shifting elements in the waveguide region, wherein each one of the plurality of phase shifting elements is adjacent to a respective one of the waveguides in the phase shifting region, and wherein each one of the plurality of phase shifting elements has a different length.

19. The method according to claim 18, wherein the each of the plurality of phase shifting elements comprises a respective segment of a continuous heating element, wherein the first electrical signals are applied across opposite ends of the continuous heating element, and wherein the second electrical signal is applied across opposite ends of the continuous heating element.

20. The method according to claim 19, wherein the continuous heating element comprises a continuous serpentine heating element.

21. The method according to claim 18, wherein each of the plurality of phase shifting elements comprises a respective segment of an electro-optic phase shifting material.

22. The method according to claim 21, wherein the phase shifting region further includes a plurality of alternating positive and negative modulation electrodes adjacent the segments of the electro-optic phase shifting material, wherein the first electrical signal is provided across the alternating positive and negative modulation electrodes to generate first electrical fields through the segments of the electro-optic phase shifting material, and wherein the second electrical signal is provided across the alternating positive and negative modulation electrodes to generate second electrical fields through the segments of the electro-optic phase shifting material.
